(19) United States
(12) Patent Application Publication
(10) Pub. No.: US 2007/0016436 A1
(43) Pub. Date: Jan. 18, 2007

(54) Computer system for resource management

(76) Inventor: Man Mohan Kakar, Commerce Township, MI (US)

Correspondence Address: REISING, ETHINGTON, BARNES, KISSELLE, P.C., P O BOX 4390, TROY, MI, 48099-4390, US

(21) Appl. No.: 11/387,230

(22) Filed: Mar. 22, 2006

Related U.S. Application Data
(63) Continuation-in-part of application No. 11/179,181, filed on Jul. 12, 2005, now abandoned.

(51) Int. Cl. G06Q 99/00

(52) U.S. Cl. 705/1

(57) ABSTRACT

A method of assessing qualifications of employment candidates includes computer-based processes. The computerized method allows the selection of at least one desired skill from the employment candidates. The computerized method includes searching electronic candidate information for the desired skills, determining duration of each skill found, and determining how recently each employment candidate used the desired skills. The computerized method automatically returns search results sorted by the qualifications of the candidates.

### CROSS-REFERENCE TO A RELATED APPLICATION

This application is a continuation-in-part application of U.S. patent application Ser. No. 11/179,181 filed Jul. 12, 2005.

### FIELD OF THE INVENTION

The present invention relates generally to computer-based human resource processes, and more particularly, to a process of evaluating employment candidate information.

### BACKGROUND

Employers and recruiters have long been confronted with the problem of locating qualified candidates to fill employment positions. Typically, a specific set of skills and a minimum amount of experience for each skill is required for an employment position. Matching qualified candidates with open positions can be challenging. Usually, the only way to evaluate the qualifications of candidates is to read each candidate's resume and manually look for specific skills and experience desired. Attempting to read, analyze, and sort resumes to determine which candidates are qualified for various employment positions is a daunting task.

Today many resumes are submitted in electronic form through email and the internet. These methods of delivery allow more candidates to submit their resumes to companies. It is common for a company or recruiter to receive dozens or even hundreds of resumes from employment candidates. Although companies and recruiters desire to have a large pool of candidates to choose from, manually evaluating the resumes of each candidate is very time consuming and tedious. In addition, companies and recruiters often desire to keep promising resumes on file so that they can evaluate current candidates to fill positions that become available in the future. But it is difficult to review a large volume of resumes to see if any candidates are qualified to fill new positions. Moreover, maintaining a current list of qualified candidates, and keeping that list of candidates available, is labor intensive.

### SUMMARY OF THE INVENTION

In accordance with one aspect of the present invention, a computerized system and method of assessing the qualifications of employment candidates includes importing unstructured electronic files into computer memory, each file containing electronic candidate information stored as unstructured data, and reading the electronic candidate information. The electronic candidate information is preprocessed to identify date pairs with the electronic candidate information from the file. A user selects at least one skill to search for in the electronic candidate information. The system searches for the selected skills in the electronic candidate information from the same file and produces search results. The system calculates a duration for each skill in the search results from the date pairs, sorts the search results into an order, and presents the sorted search results.

Preferably, the computerized method further includes selecting a single skill on which to sort the search results into an order. The step of sorting the search results into an order includes one of the following: sorting the search results based on the duration of the single skill, sorting the search results based on how recently the single skill was used by each employment candidate, or sorting the search results using a weighted sum calculation on the durations of the search results for each employment candidate.

Desirably, the computerized method of assessing the qualifications of employment candidates includes storing electronic candidate information in a database. Presenting the electronic candidate information further includes highlighting the selected skills found in the electronic candidate information. The system displays the search results in a color-coded tabular format and includes listing the respective selected skills and the durations of each selected skill.

Preferably, the system scans the electronic candidate information for headings and marks the positions of the headings. Then the system searches for the selected skills in the electronic candidate information by locating date pairs within the electronic candidate information, calculating the duration of each date pair, and applying the duration of each date pair to the selected skills found within the date pair.

According to another aspect of the invention, a computerized method of assessing the qualifications of employment candidates includes preprocessing electronic candidate information formatted as unstructured data in an unstructured electronic file to extract project segments and date pairs related to the project segments. The user selects at least one skill to search for in electronic candidate information from the same file. The system searches for the selected skills in the electronic candidate information from the same file and produces search results. The system calculates a duration for each skill in the search results from the date pairs. A user selects a single skill on which to sort the search results and the system sorts the search results into an order based on the single skill. The search results and the duration of each skill are graphically displayed in a chart.

According to yet another aspect of the invention, a computerized method of assessing the qualifications of employment candidates includes importing unstructured electronic files, each file containing electronic candidate information stored as unstructured data, and reading the electronic candidate information. The electronic candidate information is preprocessed to extract the project segments and the date pairs related to the project segments within the electronic candidate information from the file. A user selects at least one skill to search for in the electronic candidate information from the file. The system searches for the selected skills in the electronic candidate information from the same file and produces search results. The system calculates a duration for each skill in the search results from the date pairs and sorts the search results into an order. The search results and the duration of each skill are graphically displayed in a chart. The system displays the search results in a color-coded tabular format and includes listing the respective selected skills and the durations of each selected skill.

### BRIEF DESCRIPTION OF THE DRAWINGS

The advantages and features of the method of assessing the qualifications of employment candidates of the present invention will be readily apparent with reference to the appended description, claims and drawings, wherein:

FIG. 1 is a block diagram showing an, embodiment of a computer based candidate assessment system;

FIG. 2 is a block diagram showing an overview of an embodiment of a system for assessing the qualifications of employment candidates;

FIG. 2A is a block diagram showing the main menu of the system of FIG. 2;

FIG. 3 is a flowchart showing an embodiment of a skills input interface;

FIG. 4 is an illustration of the skills input interface of FIG. 3;

FIG. 5 is a flowchart showing an embodiment for a file input user interface;

FIG. 6A is a flowchart of a portion of a skills profile extraction process;

FIG. 6B is a flowchart of a second portion of the skills profile extraction process of FIG. 6A;

FIG. 6C is a flowchart of the remaining portion of the skills profile extraction process of FIG. 6A and 6B;

FIG. 7 is a flowchart of an embodiment of an extract resume segments process;

FIG. 8 is a flowchart of an embodiment of an extract project segments process;

FIG. 9 is an illustration of an example of a skills profile table;

FIG. 10 is an illustration of a sample bar chart;

FIG. 11 is an illustration of a portion of an output interface;

FIG. 12 is an illustration of a candidate information screen;

FIG. 13 is an illustration of a skill information screen;

FIG. 14 is an illustration of a submission status screen; and

FIG. 15 is an illustration of a vendor information screen.

### DETAILED DESCRIPTION OF THE PREFERRED EMBODIMENT

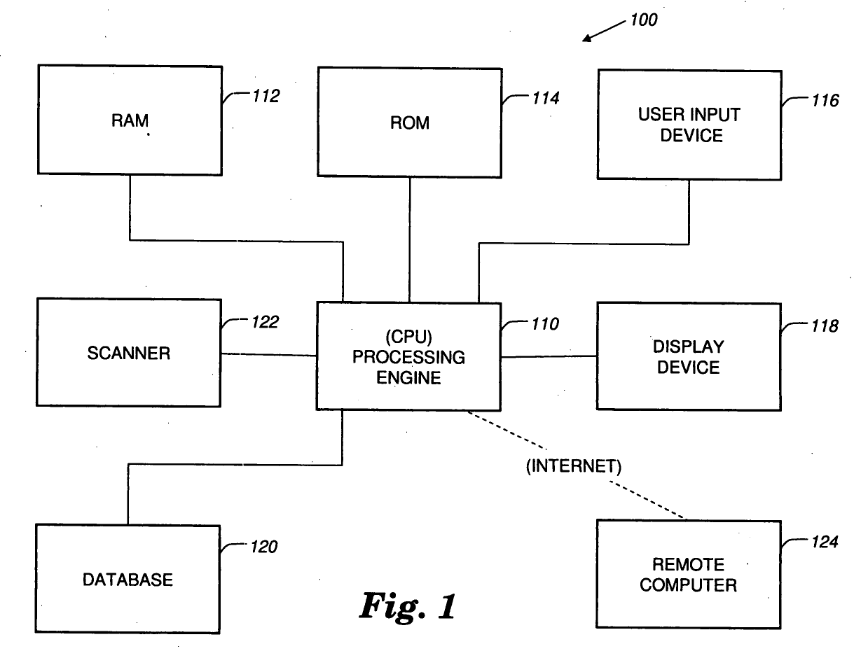

In general, the invention relates to a computer based system and a method for assessing the qualifications of employment candidates. Referring to the drawings, a computer hardware overview of a system for assessing the qualifications of employment candidates is generally shown at 100 in FIG. 1 in block diagram form. The system 100 includes a central processing unit (CPU) 110, referred to as a processing engine, that may be a microprocessor, microcomputer, minicomputer, macro computer, or a mainframe computer. The system 100 also includes a random access memory device (RAM) 112 and a read only memory device (ROM) 114, each connected to the CPU 110. The system 100 also includes a user input device 116, i.e. a keyboard, for entering data and commands into the system 100 and a display device 118 for displaying information. The system 100 also includes a database 120 converting printed documents to electronic data and importing the electronic data into the system 100. The scanner converts printed documents, such as resumes, into computer readable electronic files. In addition, the system 100 may link to remote computers 124 using TCP/IP or other Internet protocols.

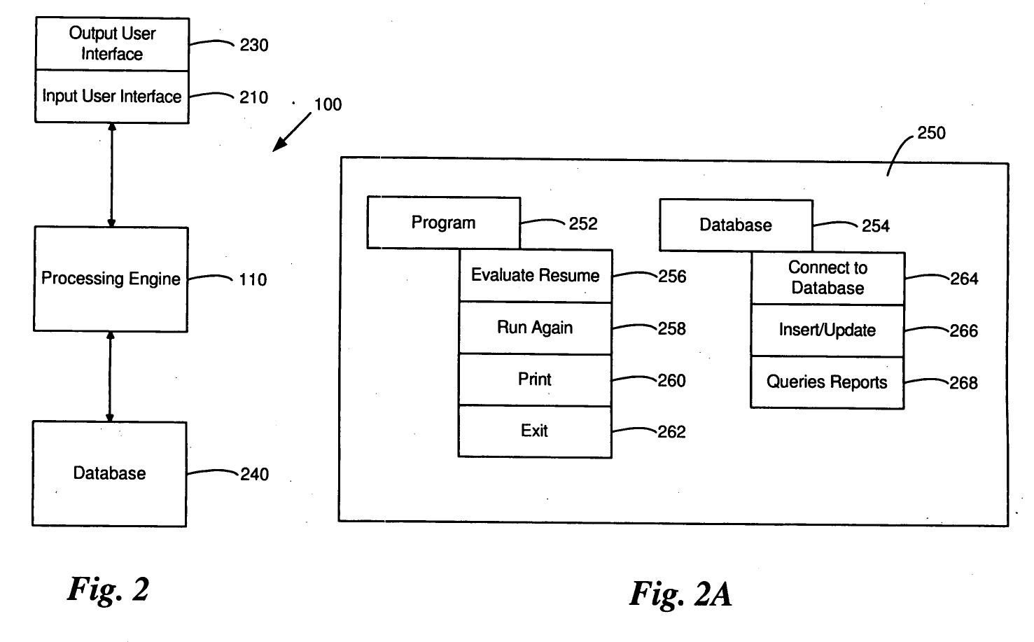

FIG. 2 illustrates a functional overview of the computer based system generally indicated at 100. The system 100 comprises the processing engine 110, an input user interface 210, an output user interface 230, and a database 240. The input user interface 210 allows a user to input criteria for searching employment candidate information. The input user interface 210 allows the user to select which electronic files to search. The processing engine 110 processes the selected electronic files, searches using the input criteria, and generates search results. The output user interface 230 displays the results generated by the processing engine 110. The database 240 stores and retrieves candidate information.

FIG. 2A represents the main menu 250 available to the user when the user first launches the system 100. The main menu 250 provides two main categories, ‘Program’ 252 and ‘Database’ 262, and several options under each category. Under ‘Program’ 252, the user can select ‘Evaluate Resume’ 254 to begin evaluating resumes, ‘Run Again’ 256 to continue evaluating resumes, ‘Print’ 260 to print a screen, or ‘Exit’ 262 to exit the system. If the user selects ‘Evaluate Resume’ 254, the processing engine 110 launches the input user interface 210.

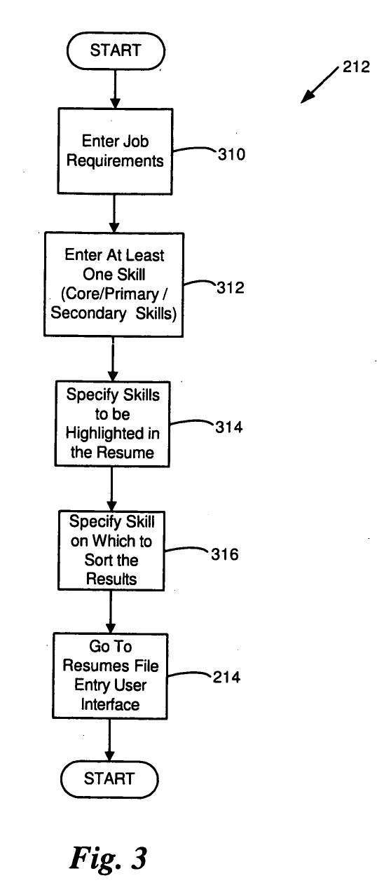

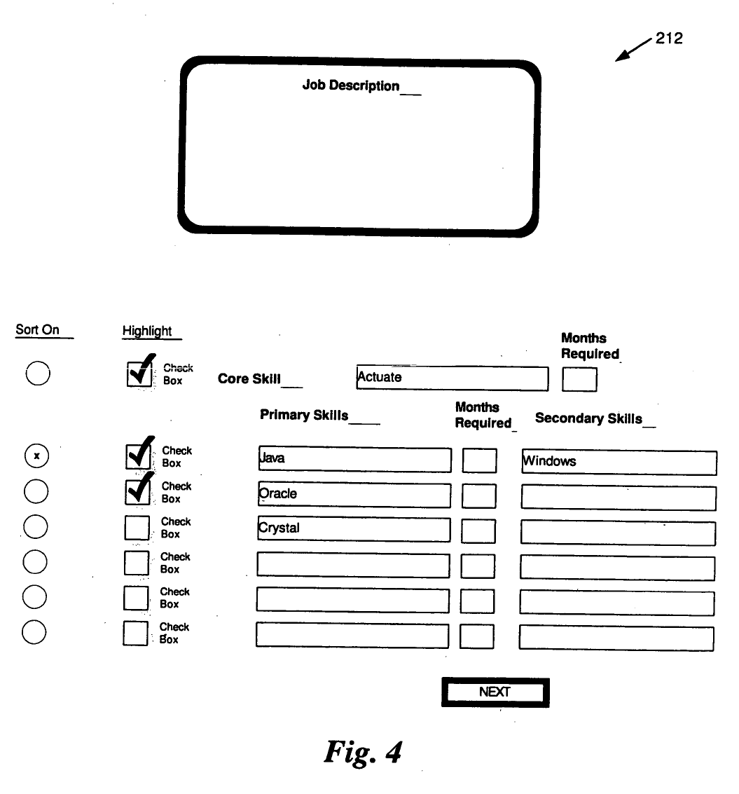

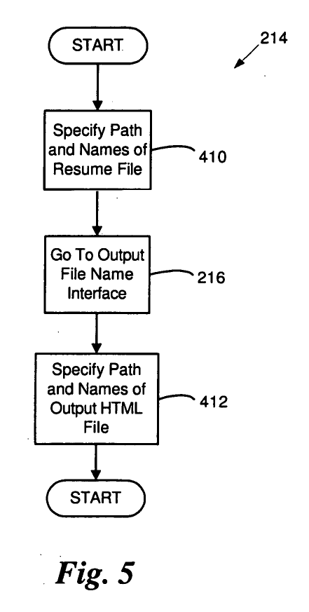

Referring now to FIGS. 3 and 5, the input user interface 210 contains a skills input user interface 212 for selecting search criteria for searching candidate information, a file input user interface 214 for importing candidate information into files and selecting the files to search, and a file output user interface 216 for selecting to store the search results. FIG. 3 illustrates an embodiment of the skills input user interface 212. At step 310, a user may enter job requirements into the system 100 using the input device 116. At step 312, the user enters skills required for a given employment position. Three main categories of skills are available: core, primary, and secondary. In one embodiment, the user may enter up to one core skill, six primary skills, and six secondary. But other embodiments may vary the allowed maximum number of skills entered in each category. The categories of skills allow the user to evaluate the importance of each skill required for a given employment search. The user must enter at least one skill for the process to continue. Later in the process, the skills entered will be located using a regular expressions search. Therefore, to increase the accuracy of finding the desired skills, the user may enter various forms of the skill. For example, if the user wants a candidate to have experience repairing automobiles, the user could enter the search words “automobile repair,” “car repair,” “auto repair,” or “mechanic” as the skills to search. The user may also enter the number of months of experience required for each core and primary skill entered as shown in FIG. 4. At step 316, the skills input user interface 212 also allows the user to select which skill to sort the skill search results. As an optional step 314, the user may select multiple skills for highlighting. The selected skills will be highlighted in candidate information displayed on the output user interface after the skills search is completed. In one embodiment, the user may select up to a maximum of three skills for highlighting. If more skills are selected for highlighting, highlighting will be applied in the order of skills selected until the maximum number has been reached. FIG. 4 represents a sample screen for the skills input user interface 212. After completing all of the steps in the skills input user interface 212, the user then presses [NEXT] in the skills input user interface and is then presented with the file input user interface 214.

The file input user interface 214 allows the user to select electronic candidate information to search as selected from the skills input interface 212. The electronic candidate information may be stored locally in RAM or ROM, or in an optional database, and is typically stored as data files. Referring to step 410 as shown in FIG. 5, the user selects the path where the appropriate data files are located and selects the data files to search. The list of files selected is called a resume file list. After completing all of the steps in the file input interface 214, the user then presses [NEXT] in the interface and is then presented with the file output user interface 216.

The file output interface 216 allows the user to select where to store search results by specifying a path and names of an output file or files in step 412. The output files may contain a profile of the skills located during a search. The file may also be generated using hypertext markup language (HTML) to provide a color-coded tabular representation of the results. The file output interface 216 recommends a default file name and location to save the file to the user. The user has the option of selecting the default file name and location, or may choose another file name or location if desired. If the chosen file name already exists in the chosen location, the user is asked to choose another file name or to choose to overwrite or append the existing file.

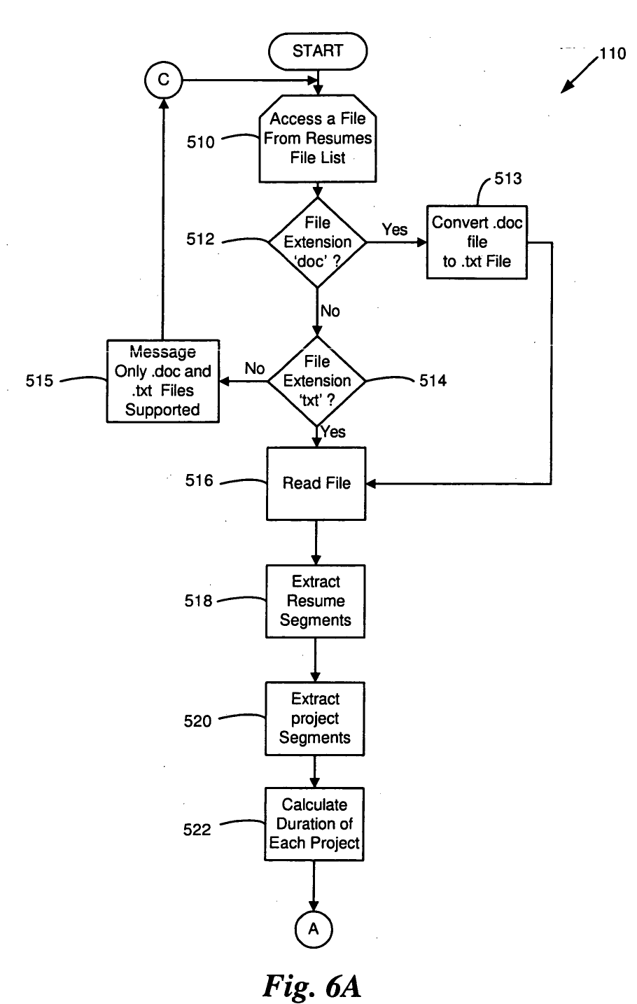

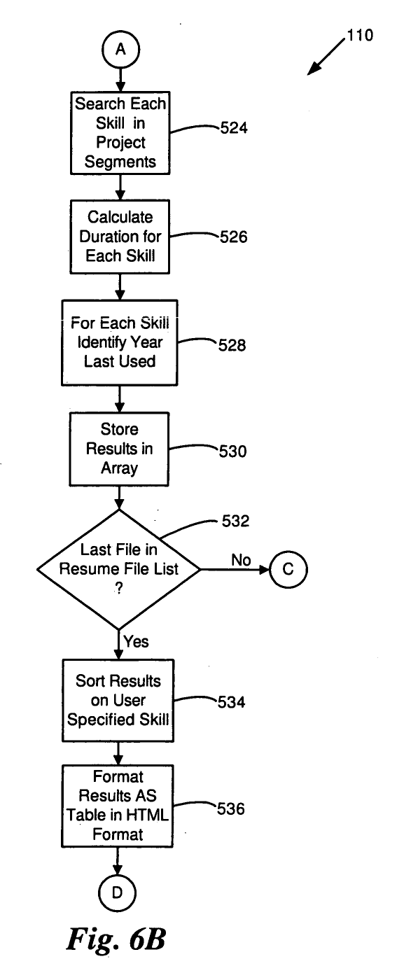

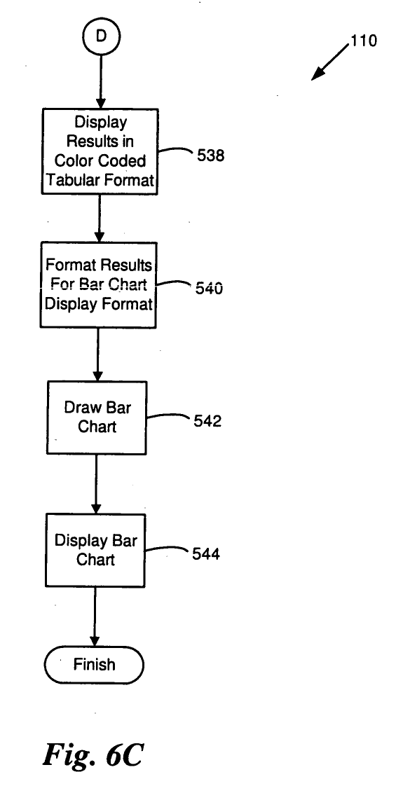

After the user has finished with the output user interface 216, the processing engine 110 obtains the candidate information from the selected files, searches the electronic candidate information, and generates search results. FIGS. 6A, 6B, and 6C provide an overview of the steps performed by the processing engine 110. First, the processing engine 110 must obtain the candidate information data from the files selected on the file input interface 216 as shown in FIG. 6A. The processing engine 110 accesses a file from the resume file list at 510. The processing engine 110 checks the file extension of each file in the file list to determine if the file is stored in a format supported by the processing engine. The processing engine 110 supports various file formats including ASCII files (.txt extension), and Microsoft Word™ files (.doc extension) as represented in FIG. 6A. The processing engine 110 may also be enabled to support other file formats not represented here. The processing engine 110 checks whether the file is an ASCII file at 514. If the file is an ASCII file, the processing engine 110 reads the file into system memory at 516. If the file is not an ASCII file but is a file format supported by the processing engine 110, the processing engine converts the file to an ASCII file at 513 and reads the file into system memory at 516. If the file format is not supported by the processing engine 110, the output interference 216 displays a message at 515 indicating that the selected file is not supported by the system 100. As previously mentioned, the system 100 may include a document scanner 122 to electronically read printed documents such as resumes into the system 100 and stored them as readable files.

The system 100 handles resumes created and submitted by employment candidates. The system 100 does not require the candidates to enter their resume or employment information into pre-determined forms. In addition, the format of the employment information data submitted will vary. Specifically, the employment information data handled by the processing engine is stored as unstructured data in an unstructured file. Unstructured data is data that does not reside in fixed locations such as in fields. An example of unstructured data is free-form text in a word processing document. In contrast, structured data is any data that resides in fields such is within a database record or spreadsheet file. Additionally, unstructured electronic files are computer files that do not contain data fields or data records. Conversely, structured files are computer files that do contain data fields or data records. Examples of structured files are database files or spreadsheets. Consequently, structured files may include free-form data stored as a free-form database field/record because the record is divided into fields. It is possible, however, to have an unstructured electronic file stored within a database. The unstructured format of the data and the file prevents the processing engine 110 from knowing where to locate specific information, such as the candidate's work experience, skills, etc., within the file. Therefore, the processing engine 110 preprocesses the unstructured data files prior to searching for the selected skills so that the processing engine 110 can analyze the data within the data files properly. Preprocessing the data files includes extracting recognizable segments of resumes at 518, extracting employment projects from resumes at 520, and calculating the duration of each project at 522.

Extracting resume segments serves two purposes. First, identifying individual segments of each resume reduces the search time required when locating desired skills. By knowing which sections of a resume contain work related experience, the processing engine can focus the skills searches to just the relevant sections. Second, extracting resume segments assists in automatic population of resume input templates as discussed later.

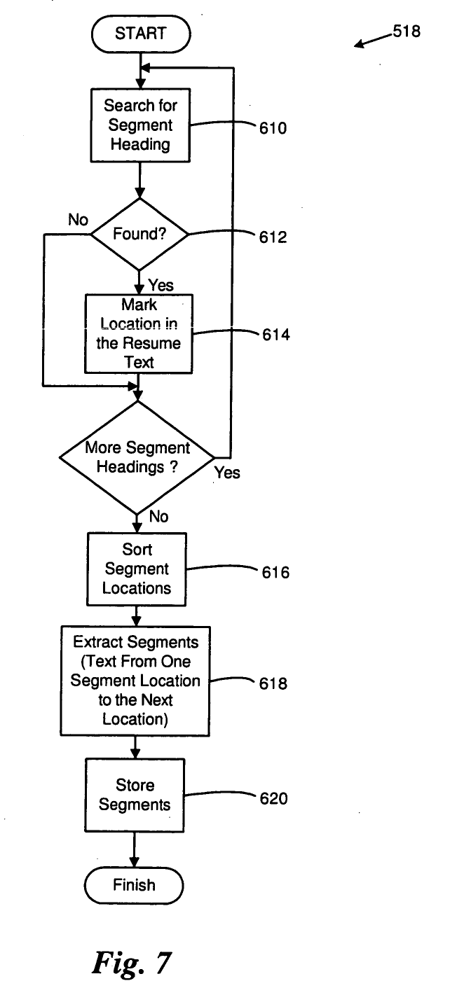

FIG. 7 illustrates an overview of the steps 518 for extracting the individual resume segments. Resumes are generally formatted into different segments such as Personal Information, Profile Summary, Technical Summary, Education, Work Experience, etc. The first step in extracting resume segments is to search each data file for commonly used headings at step 610. For example, the possible heading for a work experience segment may include ‘Work History’, ‘Employment History’, ‘Experience’, ‘Professional Experience’, ‘Project Profile’, etc. The processing engine 110 looks for each known segment heading within each data file using regular expressions. Once a recognized heading is found at step 612, the processing engine 110 marks the position in the text file where the heading is located at step 614. The processing engine continues searching the data file until the processing engine has searched all of the known headings in the data file. The processing engine then sorts the positions of the headings at 616 so that the system 100 can identify and extract the text between each of the headings at 618. The extracted text is then stored in system memory such as the RAM 112 or ROM 114 at step 620.

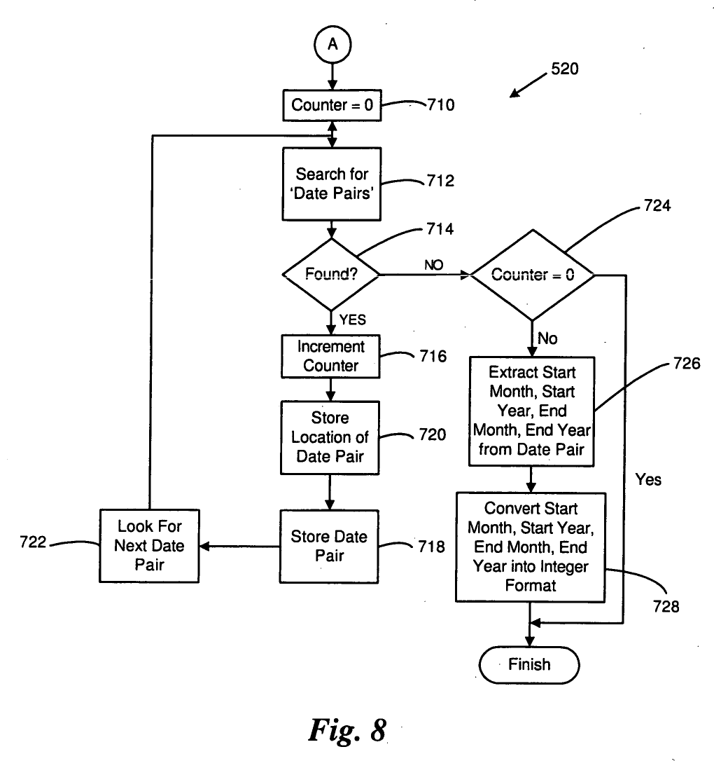

After extracting the resume segments at 518, the next step is to extract individual project segments from the appropriate resume segment containing work experience at 520. FIG. 8 provides an overview of the process 520 for extracting project segments. The first step in extracting project segments is to locate “date pairs.” A date pair is two consecutive dates within a data file. A single date found within a data file is not a date pair unless another date closely precedes or succeeds it. The dates may be stored in any number of formats such as February 2003-Current, March 2002-December 2002, Mar ‘01 to May’02, 04/99-10/02, and so on. The date pairs identify the beginning and end of each project segment, except that the end of the last project segment is determined by the end of resume segment.

To extract the individual project segments, a counter value is set to zero at 710. The processing engine searches the resume segment for a date pair using regular expressions at 712. If a date pair is found at 714, the counter value is incremented by one at 716. The processing engine 110 stores the date pair into an array at 718 and the date pair's location at 720. The process continues at 722 until no more date pairs are found. If no date pair is found in the resume segment at 714 and the counter value is still at zero at 724, then it is not feasible to automatically evaluate the data file for project specific information because no date pairs exist in the file. In such a data file, it will be difficult to assess the candidate's length of experience in skills of interest and when the skills were last used. To circumvent this problem, a user may enter date pair information into the data file to allow the system 100 to automatically evaluate the candidate information.

If the counter value is not zero at 724 after no more date pairs are found, then the processing engine 110 begins evaluating each date pair. First, the processing engine 110 must extract the start and end months and years from each date pair at 726. To extract the months and years, the processing engine 110 determines whether the date pairs are in character format or digital format. Character format means that the months are represented alphabetically, such as for example, March or Mar. Digital format means that the months are represented numerically. If the date pairs are in character format, the first word in the date pair is the start month and the second word in the date pair is the end month. For example, March 1999-May 2000, March is the first word and start month and May is the second word and end month. Note that both the end month and end year are determined to be present if the words Current or Present are used as the end date of the date pair. If the date pairs are in digital format, a different method is used to locate the start and end months of the month and year. The start month is the first digit sequence (one or two digits in length) within a date. Using 4/99 as an example, the month is the first single digit number “4.” After extracting the start month, the end month is extracted from the second date in the date pair in the same manner.

The year is determined to be the last two or four-digit number within the date for both character and digital format, unless the end date is represented by a word such as Current or Present as previously described. The processing engine extracts the start month and year from the first date, and extracts the end month and year from the second date once the processing engine has determined their locations.

Once the start and end months and years have been extracted at 726, they are stored in an array. The processing engine converts the years to four-digit year format, and converts the months to two-digit month format at 728. In the cases where the project end date is represented by a word such as ‘Current’ or ‘Present’, the current system date is used as the end date.

Referring now to FIG. 6A, the next step in the skills extraction process 500, is to calculate the duration of each project at 522. The processing engine 110 determines the duration of each project in months by calculating the number of months elapsed between the start date and the end date of each date pair. In some rare cases, a data file may contain only the years and not the months associated with each project. In these circumstances, the duration of each project may be optionally calculated using only years. Using only years to calculate duration results in an accuracy within eleven months.

After processing the date pairs for each project at 522, the processing engine 110 searches for the desired skills in each project segment at 524 as shown in FIG. 6B. The processing engine 110 searches each project segment for the skills entered in the input user interface using regular expressions. The system 100 records each skill found and the number of times each skill is present within each project segment.

Next, the system 100 calculates the total duration at 526 (or total amount of experience) of each skill found at 524. The duration of each skill is calculated by adding together the durations of each project containing the skill whose experience is being calculated. If a skill occurs more than one time in a given project, the duration of the project is added only one time.

At step 528, the system 100 calculates how recently the candidate used each skill at 528. For a given skill, the system 100 locates the end date in the date pair of each project associated with the given skill. The most recent end date located determines how recently the candidate used each skill.

The results of the skills search are stored at 530 in a set of arrays containing the following information: the project durations, the date each skill was last used, the total duration of experience of each skill, and the number of times each skill was found in each project. The system 100 performs the skills profile extraction for each data file specified by the user in the file input interface at 532 and stores the results in the results array at 530.

Once the results array is complete at 530, the system 100 sorts the results array based on the skill specified by the user in the skills input interface at 534. The sort allows the system 100 to determine the most qualified candidates based on the information in the results array. The system 100 performs a first sort on the results array 530 based on the total skill duration of the selected skill from most experience to least experience. The system 100 performs a second sort on the result of the first sort to further order the results array according to how recently the candidate used each skill.

Alternatively, the system 100 could perform the sorts using a weighted sum of all of the skills entered in step 312, or a subset of the skills. In addition, the system 100 could predetermine the weighting of the weighted sum or the user could modify the weighting. The exact formula for applying a weighted sum calculation to analyze the skills is not critical so long as the result provides an objective value to assist a user in evaluating the qualifications of a candidate. As one example of how a weighted sum calculation could be implemented, individual weights may be provided based on the importance of each skill (e.g. core, primary, or secondary skills). For example, assuming the experience duration requirements of a given skill are fully satisfied, core skills will carry a weight of 100, primary skills a weight of 90, and secondary skills a weight of 60. The weights of these skills can vary in different embodiments of the invention or may even be modified by the user.

In addition, the weighting could take into account the extent to which a candidate's experience meets the requirements entered for each skill at the skills input interface at 212. If a candidate has a selected skill but does not have the minimum experience required for that skill, the weighted sum may be programmed to ignore that skill altogether or the experience of that skill may be reduced by a given factor before being added to the sum. For example, if the required experience duration of a specified skill, say Java, is 50 months, and the experience duration calculated from the resume is 40 months, then the weight of the skill will be (40 divided by 50) times the normal weight of that category of skill (core, primary, secondary). If Java is a primary skill the weight would be (40/50) * 90=72.

For any experience over and above the required experience, the following values, if any, (or others substituted by the user) could be used to calculate the weights for primary and core skills: for 110% to 120% of the required experience, add 5 to the normal weight; for 121% to 140% of the required experience, add 10 to the normal weight; for 141% to 160% of the required experience, add 15 to the normal weight; for 161% to 180% of the required experience, add 20 to the normal weight; from 181% and up, add 25 to the normal weight. For secondary skills, the normal weight, 60, is the maximum weight. It will be apparent that many various weighting values may be used and may differ from one application to another. The concept of a weighted sum calculation, however, is well known and understood in the computer software art. It will be obvious that the system 100 could incorporate other types of sorts on the results array as well.

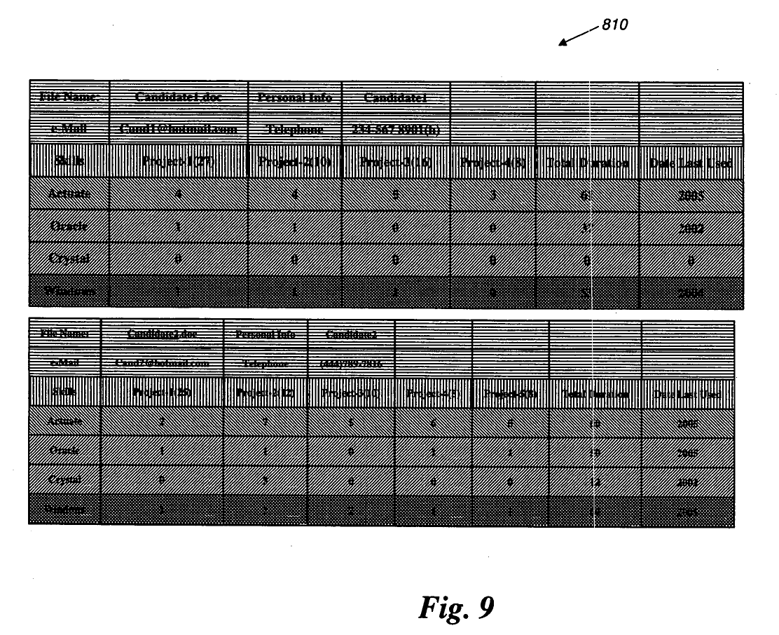

Once sorted at 534, the processing engine 110 uses the results array 530 to generate reports for later display to the user. Specifically, the processing engine 110 converts the results array 530 into a skills profile table containing data regarding the qualifications of the candidates at 536. The table is generated at 536 such that the most qualified candidates are listed first due to the sort on the results array 530. The table may be generated in any number of formats. FIG. 9 shows an example 810 of one possible format for a skills profile table generated in hypertext markup language (HTML). Once the table is generated at 536, the output interface 230 displays the table at 538.

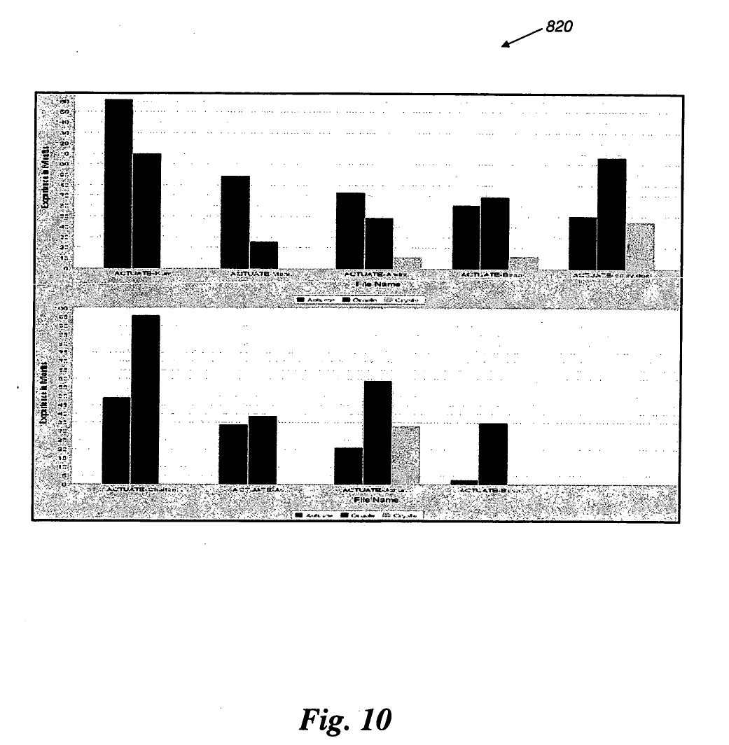

At step 540, the processing engine 110 formats the results array 530 for use in charting software used to generate bar charts for later display to the user. The bar charts will allow the user to quickly identify the most qualified candidates. FIG. 10 represents one example 820 of a bar chart generated for the user. One type of commercially available charting software that may be used is JFreeChart offered by Object Refinery Limited. As shown in FIG. 6C, once the charting software generates the bar charts at 542, the charts are presented to the user on a new window at 544 and the output interface 230 is launched in a separate window. The user may view the bar charts or the output interface 230 by clicking on a portion of the corresponding window to pull that window to the front on the display device 118.

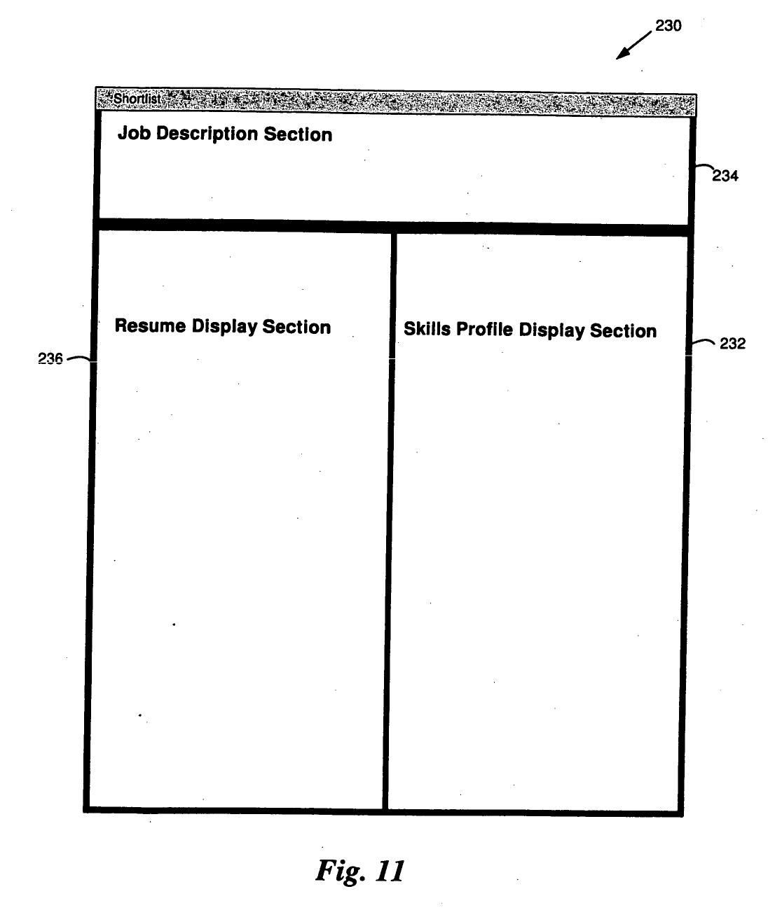

The output interface 230 provides several methods of reviewing candidate information processed by the system 100. FIG. 11 illustrates one embodiment of the output interface 230 containing three sections: a skills profile display section 232, a job description section 234, and a resume display section 236.

FIG. 9 shows a sample skills profile table 810 for display in the skills profile display section 232 of the output interface 230. The skills profile of each resume comprises a table. The skills table 810 lists each project found in the candidate's data file, each desired skill, and the number of months of experience the candidate has with each skill in each project. The top two rows of the table list the candidate's personal information and a link to the data file corresponding to the candidate. Each skill located has its own row in the table and each project found for a given candidate has its own column. Below each project, the total number of times each skill is found in the project is listed. Next to the project name, the duration of the project is listed in parenthesis. A column for the total duration of each selected skill and a column listing the last date each skill was last used are also in the table. A column for ranking scores may be included in the table. A ranking score is the ratio of a candidate's actual experience for a given skill to that of the experience entered by the user in the skills input interface. In addition, a total ranking score may be included in the table to assist the user in assessing the overall qualification of each candidate. The total ranking score is the sum of all of the weighted ranking scores for the candidate.

The resume display section 236 of the output interface 230 displays the text of a candidate's resume. To display the resume of a candidate, the user clicks on the file name for a candidate in the skills profile table 810 in skills profile display section 232. The file name is a link that brings up the associated resume in the resume display section 236. The skills selected by the user in the skills input interface 212 at 312 are highlighted in the resume display section 236 in multiple colors to assist the user in quickly finding references to the skills.

The job description section 234 of the output interface 230 displays the job description entered by the user in the skills input interface. In addition, the job description section 234 lists files associated with candidates selected to a short list. The system 100 provides a method for the user to create a short list of candidate profiles after the user has evaluated the various tables and charts generated by the system 100. Specifically, to generate a short list, the user clicks in the skills profile display section 232 on the resume file name of the candidate he wants to add to the shortlist. The resume display section 236 displays that candidate's resume. The user then selects the ‘Add to shortlist’ option in the system 100. The candidate's resume is added to the shortlist and the filename of the shortlisted candidate is displayed in the job description section 234. After finishing selecting candidates for inclusion in the short list, the user selects ‘Display Shortlist Results’ in system 100. The system 100 then automatically generates fresh skills profiles of the candidates in the shortlist and displays the results in the output interface 230 and bar chart 820 following the processes previously described. The output user interface 230 and the bar chart 820 are displayed in separate windows. The user can view either window by clicking on it to bring it to the front. The user can save the new results in a separate file in a format such as HTML.

The user may view the bar charts generated by the processing engine 110 by selecting the window containing the bar charts. FIG. 10 shows a bar chart 820 listing the number of months of experience for each skill selected for each candidate. In one embodiment, the number of months of experience for up to three core and primary skills may be displayed for each candidate. But a larger number of skills can be listed if desired. To provide for readability and provide a maximum amount of information, the bar chart 820 in FIG. 10 lists a maximum of five candidates' bar charts on each row, and displays one row of bar charts below the other. The bar chart 820 also contains a legend showing the names of skills displayed in the bar chart. The bar chart 820 is useful to the user because it provides a very simple and effective way to visually present the qualifications of multiple candidates to the user. The user can glance at the bar chart 820 containing the sorted list of candidates and quickly determine which of the candidates appear to be the most qualified.

An optional feature for the system 100 includes a relational database 120 for storing and retrieving electronic employment information. The database 120 offers advantages such as the ability to do queries/searches, reports, and as a repository of information. The system 100 can create tables on the database required to form a database for resume evaluation. The tables are designed to store database information necessary to respond to queries on a candidate's skill set, personal information (such as name, address, telephone number, etc.), current and expected compensation, availability status, authorization to work, resume, status of employment application, and any information regarding the candidate's supplier if applicable. Varying embodiments can incorporate various databases.

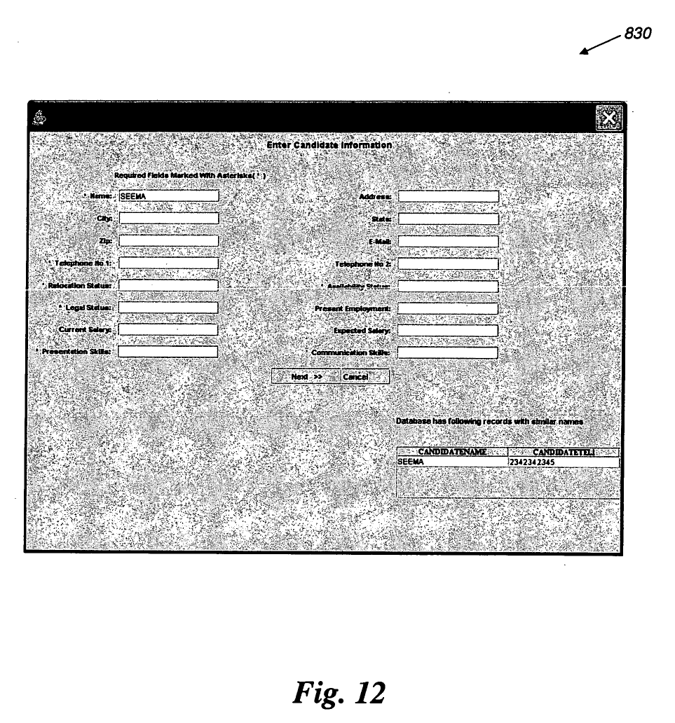

Candidate information is entered into the database 120 both automatically and manually. To begin entering candidate information, the user first selects ‘Connect to Database’ 264 from the main menu 250 to begin accessing the database 120. The user may then select ‘Insert/Update’ 266 from the main menu 250 to bring up a candidate information screen 830. An example of the candidate information screen 830 is shown in FIG. 12. The screen 830 prompts the user to enter candidate information into entry fields. At first, the screen has only two fields enabled. The enabled fields are ‘Name’ and ‘Telephone No 1.’ The user begins by entering the candidate's name into the ‘Name’ field following by the phone number into the ‘Telephone No 1’ field. In order to prevent duplicate candidates from being entered, the system 100 checks the database 120 to see if a candidate with a similar name already exists in the database 120 as soon as the user selects the ‘Telephone No 1’ field. If a similar name exists, the name of the similar candidate or candidates is displayed on the lower part of the screen 830 as shown in FIG. 12. The user may then select any candidate list to view further details of that particular candidate in the entry fields of screen 830. In addition, the user can view and edit information of a previously entered candidate in the database 120. If a duplicate candidate exists in the database 120, the user is given the option to update that candidate's information in screen 830, or leave the information unchanged. When entering candidate information into screen 830, some of the fields may be left blank if the information is not available at that time. The user is required to enter information into particular fields designed with an asterisk next to the field names. After the user has completed entering the candidate information into the fields, the user clicks [NEXT] on screen 830 to enter the information into the database 120 and a skill information screen 840 is displayed.

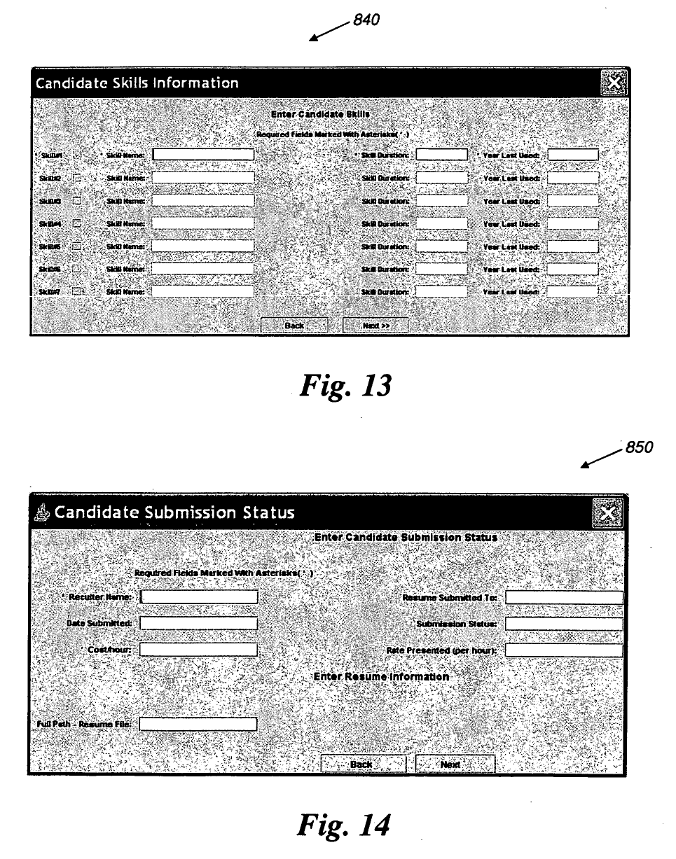

The skill information screen 840 displays existing skill information to the user. FIG. 13 represents an example of the skill information screen 840. The system 100 automatically fills in the skill information screen 840 using the data obtained from the skills profile extraction process 500. The system 100 will populate the skill information screen 840 if the user selects a menu option ‘Populate Skills’ (not shown) on the skill information screen 840. The user is then prompted to select the skills profile file 412 containing the candidate information of interest. The fields on the skills information screen 840 are then populated.

Once the skills information screen 840 fields are populated, the user can edit the fields and add more skills if so desired. The user can go back to the previous entry screen by clicking [BACK], or the user can go to submission status screen 850 by clicking [NEXT].

As shown in FIG. 14, the submission status screen 850 displays fields related to the name of the recruiter, the status of a candidate's application, costs associated with hiring the candidate, the price charged to the employer for any consulting services, and the path for the resume file stored in the database 120. The user may bring up the skill information screen 840 by clicking [BACK] or bring up a vendor information screen by clicking [NEXT].

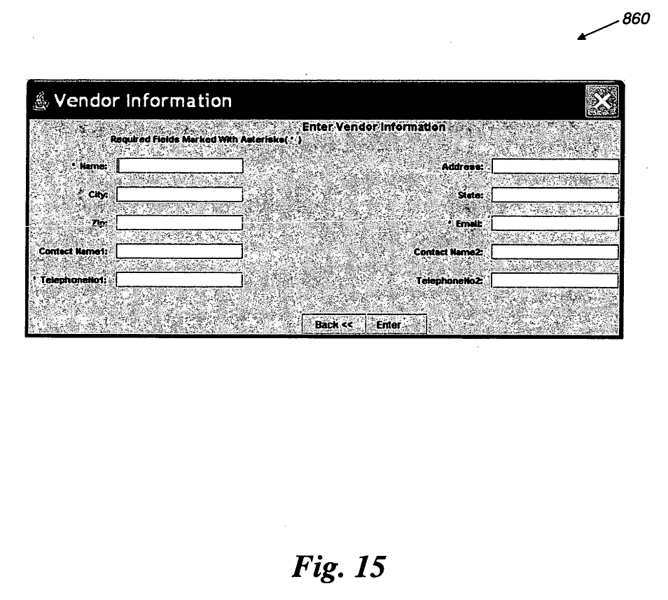

The vendor information screen 860 displays vendor information such as the vendor's name, address, phone numbers and e-mail address as shown in FIG. 15.

The system 100 also contains queries preprogrammed for use with the database 120 to aid the user in obtaining information from the database. The user can access the queries by selecting ‘Queries Reports’ 268 from the main menu 250. The queries are hard coded in the system 100 and require inputs from the user only with regard to the search parameters. For example, one of the queries that are frequently used by users is a search for a given set of skills. By using a preprogrammed query and entering the skills desired, the user will be able to quickly and easily obtain the relevant candidates with those skills.

It will thus be apparent that there has been provided in accordance with the present invention a computer based system 100 and method that achieves the aims and advantages specified herein. It will be understood that the foregoing description is of a preferred exemplary embodiment of the invention and that the invention is not limited to the specific embodiment shown. For example, the structure of the system 100 and all of its various sub-components could vary from that shown in the Figures and discussed in the specification. Objects, data, functions, logic, etc. could be added, omitted, or otherwise altered from that specifically shown. In addition, there are numerous instances where information is said to be stored in the form of a particular array, value, string, flag, etc. These values could just as easily be stored in the form of additional objects, or any other type of data known in the art. Moreover, the particular sequences, steps, etc. and their corresponding order of execution could differ from that previously discussed, as the embodiments shown herein were merely intended as an example. Various changes and modifications are intended to be within the scope of the present invention.

1. A computerized method of assessing the qualifications of employment candidates, comprising the steps of:
(a) importing unstructured electronic files into computer memory, each file containing electronic candidate information stored as unstructured data, and reading said electronic candidate information;
(b) preprocessing said electronic candidate information to identify date pairs within said electronic candidate information from said file;
(c) selecting at least one skill to search for in said electronic candidate information;
(d) searching for the selected skills in said electronic candidate information from said same file and producing search results;
(e) calculating a duration for each skill in said search results from said date pairs;
(f) sorting said search results into an order; and
(g) presenting said sorted search results.

2. The computerized method of assessing the qualifications of employment candidates as claimed in claim 1, further including selecting a single skill on which to sort said search results into an order.

3. The computerized method of assessing the qualifications of employment candidates as claimed in claim 2, wherein the step of sorting said search results into an order includes sorting said search results based on the duration of said single skill.

4. The computerized method of assessing the qualifications of employment candidates as claimed in claim 2, wherein the step of sorting said search results into an order includes sorting said search results based on how recently said single skill was used by each employment candidate.

5. The method of assessing the qualifications of employment candidates as claimed in claim 2, wherein the step of sorting said search results into an order includes sorting said search results using a weighted sum calculation on the durations of said search results for each employment candidate.

6. The computerized method of assessing the qualifications of employment candidates as claimed in claim 2, wherein the step of presenting said sorted search results includes highlighting said selected skills found in said electronic candidate information.

7. The computerized method of assessing the qualifications of employment candidates as claimed in claim 6, wherein the step of highlighting said selected skills includes highlighting said respective skills in different colors.

8. The computerized method of assessing the qualifications of employment candidates as claimed in claim 1, further including storing electronic candidate information in a database.

9. The computerized method of assessing the qualifications of employment candidates as claimed in claim 1, wherein the step of preprocessing said electronic candidate information includes scanning said electronic candidate information for headings and marking the positions of said headings.

10. The computerized method of assessing the qualifications of employment candidates as claimed in claim 9, further including applying the duration of each date pair to said selected skills found within said date pair.

11. The computerized method of assessing the qualifications of employment candidates as claimed in claim 1, further including applying the duration of each date pair to said selected skills found within said date pair.

12. The computerized method of assessing the qualifications of employment candidates as claimed in claim 1, further including displaying said search results in a color-coded tabular format including listing said respective selected skills and the durations of each selected skill.

13. A computerized method of assessing the qualifications of employment candidates, comprising the steps of:
(a) preprocessing electronic candidate information formatted as unstructured data in an unstructured electronic file to extract project segments and date pairs related to said project segments;
(b) selecting at least one skill to search for in said electronic candidate information from said same file;
(c) searching for said selected skills in said electronic candidate information from said same file and producing search results;
(d) calculating a duration for each skill in said search results from said date pairs;
(e) selecting a single skill on which to sort said search results and sorting said search results into an order based on said single skill; and
(f) graphically displaying in a chart said search results and said duration of each skill.

14. The computerized method of assessing the qualifications of employment candidates as claimed in claim 13, wherein the step of sorting said search results into an order includes sorting said search results based on the duration of said single skill.

15. The computerized method of assessing the qualifications of employment candidates as claimed in claim 13, wherein the step of sorting said search results into an order includes sorting said search results how recently said single skill was used by each employment candidate.

16. The computerized method of assessing the qualifications of employment candidates as claimed in claim 13, wherein the step of sorting said search results into an order includes sorting said search results using a weighted sum of said durations.

17. The computerized method of assessing the qualifications of employment candidates as claimed in claim 13, further including storing said electronic candidate information in a database.

18. The computerized method of assessing the qualifications of employment candidates as claimed in claim 13, further including viewing said electronic candidate information and highlighting said selected skills found in said electronic candidate information.

19. The computerized method of assessing the qualifications of employment candidates as claimed in claim 18, wherein the step of highlighting said respective selected skills includes highlighting said skills in different colors.

20. The computerized method of assessing the qualifications of employment candidates as claimed in claim 13, further including applying the duration of each date pair to said selected skills found within said date pairs.

21. The computerized method of assessing the qualifications of employment candidates as claimed in claim 20, wherein the step of preprocessing electronic candidate information further includes scanning said electronic candidate information for headings and marking the positions of said headings.

22. The computerized method of assessing the qualifications of employment candidates as claimed in claim 13, further including displaying said search results in a color-coded tabular format including listing said respective selected skills and the durations of each selected skill.

23. A computerized method of assessing the qualifications of employment candidates, comprising the steps of:
(a) importing unstructured electronic files each file containing electronic candidate information stored as unstructured data and reading said electronic candidate information;
(b) preprocessing said electronic candidate information to extract project segments and date pairs related to said project segments within said electronic candidate information from said file;
(c) selecting at least one skill to search for in said electronic candidate information from said file;
(d) searching for said selected skills in said electronic candidate information from said same file and producing search results;
(e) calculating a duration for each skill in said search results from said date pairs;
(f) sorting said search results into an order;
(g) graphically displaying in a chart said search results and said duration of each skill; and
(h) displaying said search results in a color-coded tabular format including listing said respective selected skills and the durations of each selected skill.
